(19) United States
(12) Patent Application Publication
(10) Pub. No.: US 2025/0168933 A1
(43) Pub. Date: May 22, 2025

(54) CERAMIC HEATER

(71) Applicant: MiCo Ceramics Ltd., Anseong-si (KR)

(72) Inventors: Jung-Chul Jin, Anseong-si (KR); Hyung-Jun Cho, Anseong-si (KR)

(21) Appl. No.: 18/952,941

(22) Filed: Nov. 19, 2024

(30) Foreign Application Priority Data
Nov. 20, 2023 (KR) 10-2023-0161006

(51) Int. Cl. H05B 3/28; H05B 3/02

(52) U.S. Cl. CPC H05B 3/283; H05B 3/02; H05B 2203/003

(57) ABSTRACT

Disclosed is a ceramic heater. The ceramic heater includes a plate including a heating element and a first passage, and a shaft having a hollow portion. The heating element includes a plurality of concentric arc portions and a plurality of connecting portions connecting the arc portions. The plurality of connecting portions are spaced apart and face each other to form a separation area that extends in a radial direction of the plate, and the first passage is formed adjacent to the separation area.

### CROSS-REFERENCE TO RELATED APPLICATION(S)

This application is based on and claims priority under 35 U.S.C. 119 to Korean Patent Application No. 10-2023-0161006, filed on Nov. 20, 2023, in the Korean Intellectual Property Office, the disclosure of which is herein incorporated by reference in its entirety.

### BACKGROUND OF THE INVENTION

### 1. Field of the Invention

The present disclosure relates to a ceramic heater and, more specifically, to a ceramic heater having an improved passage structure into which a temperature sensor is inserted.

### 2. Description of the Prior Art

In general, in order to manufacture a flat display panel or a semiconductor device, substrates such as a glass substrate, a flexible substrate, or a semiconductor substrate are subjected to processes of sequentially laminating and patterning a series of layers including a dielectric layer and a metal layer thereon. In this case, the series of layers such as the dielectric layer and the metal layer are deposited on a substrate through a process such as chemical vapor deposition (CVD) or physical vapor deposition (PVD).

In order to uniformly form these layers, the substrate should be heated to a uniform temperature, and a substrate heating device may be used to heat and support the substrate. The substrate heating device may be used to heat the substrate during an etching process of a dielectric layer or a metal layer formed on the substrate, a firing process of a photo resistor, and the like.

The ceramic heater used as such a substrate heating device includes a heating element and a thermocouple for measuring the temperature of the heating element. The thermocouple is inserted into a thermocouple passage formed inside the ceramic heater, and heat generated from the heating element may be released through the thermocouple passage. When such heat loss occurs, it causes deterioration in the temperature uniformity of the substrate placed on the ceramic heater.

### SUMMARY OF THE INVENTION

The present disclosure aims to prevent heat loss caused by a passage through which a temperature sensor, such as a thermocouple, is inserted.

In addition, the present disclosure aims to prevent cracks from occurring in a plate of a ceramic heater due to expansion and contraction of a heating element.

In addition, the present disclosure aims to enable more accurate temperature measurement of a heating element.

Furthermore, the present disclosure aims to increase design flexibility by allowing free selection of the position for placing a temperature sensor such as a thermocouple.

An embodiment of the disclosure provides a ceramic heater. The ceramic heater includes a plate including a heating element and a first passage, and a shaft having a hollow portion. The heating element includes a plurality of concentric arc portions and a plurality of connecting portions connecting the arc portions. The plurality of connecting portions are spaced apart and face each other to form a separation area that extends in a radial direction of the plate, and the first passage is formed adjacent to the separation area.

According to an embodiment of the present disclosure, by disposing a passage where a temperature sensor is inserted in an area where a heating element is not densely packed, heat loss and cracking of the ceramic plate can be prevented.

In addition, by disposing a temperature-sensing portion of the temperature sensor close to a heating element, the temperature of the heating element can be measured more accurately.

Furthermore, by providing the temperature sensor inside the wall of a shaft, design flexibility regarding the position of the temperature sensor can be enhanced.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a perspective view of a ceramic heater according to an embodiment of the present disclosure;

FIG. 2 is a cross-sectional view of a plate according to an embodiment of the present disclosure, cut horizontally along a heating element and viewed from above;

FIG. 3 is a cross-sectional view of a plate according to another embodiment of the present disclosure, cut horizontally along a heating element and viewed from above;

FIG. 4 is a partial enlarged view of portion P of FIG. 2;

FIG. 5 is a cross-sectional view of a plate according to another embodiment of the present disclosure, cut horizontally along a heating element and viewed from above;

FIG. 6 is a cross-sectional view taken along line C-C′ of FIG. 2;

FIG. 7 is a view illustrating a comparative example in which heat loss occurs when the first passage is formed in an area where a heating element is densely packed;

FIG. 8 is a view illustrating a comparative example in which microcracks occur when the first passage is formed in an area where a heating element is densely packed;

FIG. 9 is a cross-sectional view of a plate according to another embodiment of the present disclosure taken along line C-C;

FIG. 10 is a view illustrating a process of manufacturing the plate shown in FIG. 9;

FIG. 11 is an enlarged view of portion Z in FIG. 9;

FIG. 12 is a cross-sectional view taken along line E-E in FIG. 11;

FIG. 13 is a cross-sectional view taken along line B-B of FIG. 1;

FIG. 14 is a cross-sectional view taken along line A-A of FIG. 1, illustrating a shaft according to an embodiment of the present disclosure;

FIG. 15 is a cross-sectional view taken along line D-D′ in FIG. 14;

FIG. 16 is a cross-sectional view illustrating a shaft according to another embodiment of the present disclosure;

FIG. 17 is a plan view of a ceramic heater according to another embodiment of the present disclosure;

FIG. 18 is a cross-sectional view taken along line B-B of FIG. 1, illustrating a shaft according to an embodiment of the present disclosure; and

FIG. 19 is a cross-sectional view illustrating a state in which a thermocouple is inserted into the ceramic heater of FIG. 18.

### DETAILED DESCRIPTION OF THE EXEMPLARY EMBODIMENTS

Hereinafter, embodiments disclosed herein will be described in detail with reference to the accompanying drawings. Regardless of drawing numbers, the same or similar elements will be assigned the same reference numerals, and redundant descriptions thereof will be omitted. In the following description of embodiments of the present disclosure, when each layer (film), area, pattern, or structure is described as being formed “above/on” or “below/under” a substrate, each layer (film), area, pad or patterns, the terms “above/on” and “below/under” are used to cover being formed either “directly” or “indirectly via another layer”. In addition, the criterion for above/on or below/above for each layer will be described with reference to the drawings. In the drawings, the thickness or size of each layer is exaggerated, omitted, or schematically illustrated for convenience and clarity of description. In addition, the size of each component does not fully reflect the actual size.

As used herein, expressions such as “including”, “comprising”, or “consisting of” are intended to indicate any features, numbers, steps, operations, elements, or some or combinations thereof, and should not be construed to exclude the existence or possibility of one or more other features, numbers, steps, operations, elements, or some or combinations thereof, in addition to those described above.

In addition, terms such as “first” and “second” may be used to describe various components, but the components are not limited by the terms, and these terms are only used for the purpose of distinguishing one component from another.

In addition, in describing the embodiments disclosed herein, when it is determined that detailed descriptions of related known technologies may obscure the gist of the embodiments disclosed herein, the detailed descriptions will be omitted.

It should be understood that the accompanying drawings are only for easy understanding of the embodiments disclosed herein, and that the technical idea disclosed herein is not limited by the accompanying drawings, and includes all changes, equivalents, and substitutes included in the spirit and technical scope of the present disclosure.

Hereinafter, various embodiments of the present disclosure will be described in detail with reference to the drawings.

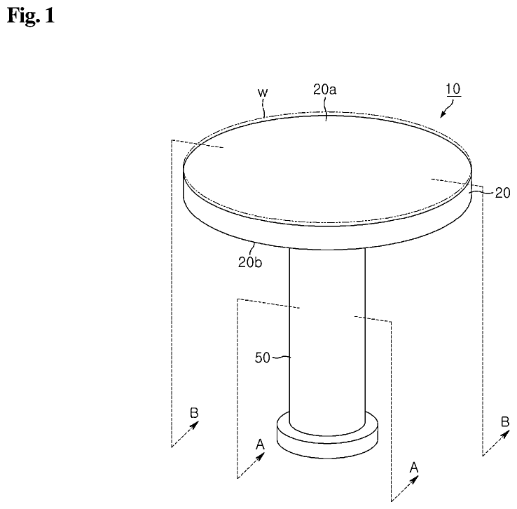

FIG. 1 is a perspective view of a ceramic heater according to an embodiment of the present disclosure.

The ceramic heater 10 is a device that supports heat treatment objects for various purposes, such as semiconductor wafers, glass substrates, and flexible substrates, and heats the heat treatment objects to a predetermined temperature.

The ceramic heater 10 includes a plate 20 on which a heat treatment object, such as a semiconductor wafer W, is mounted, and a shaft 50 coupled to a bottom surface 20b of the plate. The plate 20 has a flat mounting surface (first surface) 20a on which the heat treatment object is mounted, and a bottom surface (second surface) 20b on which the shaft 50 is coupled.

The plate 20 is a disc-shaped plate 20 that contains a ceramic material, such as aluminum nitride or alumina. The shaft 50 may be made of ceramic, such as aluminum nitride or alumina, similar to the plate 20.

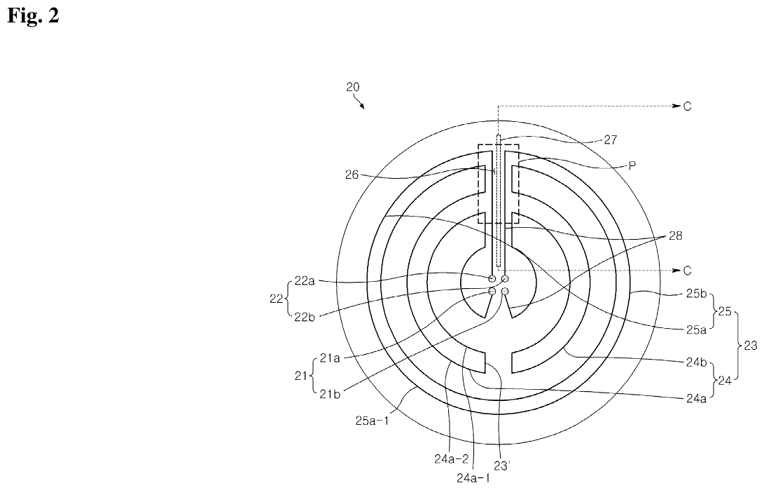

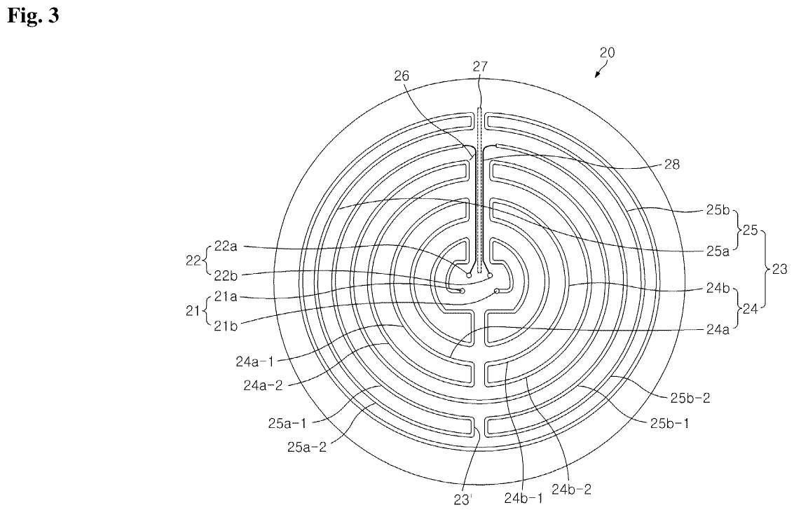

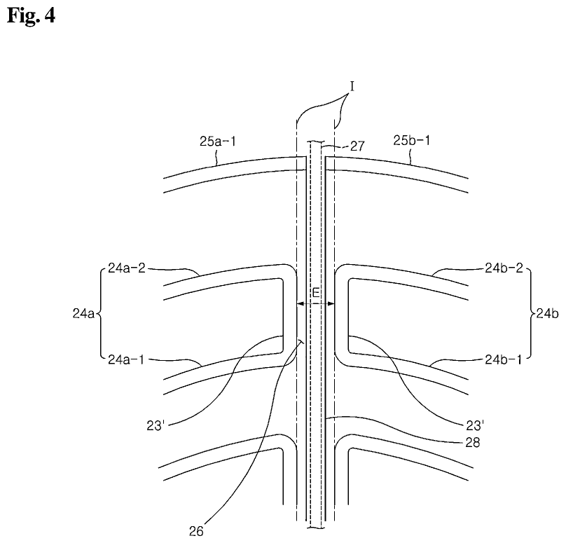

FIG. 2 is a cross-sectional view of a plate according to an embodiment of the present disclosure, cut horizontally along a heating element and viewed from above, and FIG. 3 is a cross-sectional view of a plate according to another embodiment of the present disclosure, cut horizontally along a heating element and viewed from above, and FIG. 4 is a partial enlarged view of a portion P of FIG. 2.

Referring to FIGS. 2 to 4, the plate 20 is made of a ceramic material, such as Al₂O₃, Y₂O₃, Al₂O₃/Y₂O₃, ZrO₂, AlC, TiN, AlN, TiC, MgO, CaO, CeO₂, TiO₂, BxCy, BN, SiO₂, SiC, YAG, Mullite, AlF₃, or the like, or two or more of these may be used in combination.

The plate 20 may include a heating element 23. The heating element 23 performs the function of heating a heat treatment object placed on the mounting surface 20a of the plate to a constant temperature in order to perform a smooth deposition process and an etching process in a semiconductor manufacturing process or the like.

The heating element 23 may be embedded in the plate 20 corresponding to the position of the heat treatment object. The heating element 23 may be embedded in the plate 20 parallel to the mounting surface 20a of the plate, allowing it to control the heating temperature uniformly based on its position to uniformly heat the heat treatment object as a whole by heat generation, and allowing the distance at which heat is transferred to the heat treatment object to be maintained constant at nearly all positions.

The heating element 23 may have a shape that corresponds to the shape of the heat treatment object. In addition, the heating element 23 may have a plate-shaped coil shape or a flat plate shape with a heating wire (or a resistance wire). The heating element 23 may be made of tungsten (W), molybdenum (Mo), molybdenum carbide (Mo₂C, MoC, or Mo₃C₂), silver (Ag), gold (Au), platinum (Pt), niobium (Nb), titanium (Ti), or alloys thereof. The heating element 23 may be electrically connected to terminals 21 and 22 via conductive connection portions 28.

A pair of first terminals 21 and a pair of second terminals 22 may be provided in the central portion of the plate 20. The first terminals 21 electrically connect an inner zone heating element 24 provided in the inner area of the plate 20 and a load to be described below, and the second terminals 22 electrically connect an outer zone heating element 25 provided in an outer area of the plate 20 and the load.

In the present disclosure, the heating element 23 may be configured with two or more heating elements 23 to heat several divided zones. For example, FIG. 2 illustrates a heating element 23 configured with an inner zone heating element 24 and an outer zone heating element 25 to heat respective zones by dividing the plate into an inner zone and an outer zone. Below, a heater divided into an inner zone and an outer zone is described, but the present disclosure is not limited thereto. Of course, the present disclosure is also applicable to, for example, a multi-zone heater in which the plate of a ceramic heater is divided into fan-shaped portions of predetermined angles, with heating elements provided to correspond to respective divided zones.

The inner zone heating element 24 forms predetermined concentric circle patterns, starting from a first terminal 21a, is continuously wired in the inner area of the plate 20, and is then connected to another first terminal 21b. In this process, the inner zone heating element 24 may form a plurality of concentric circle pattern shapes by being folded at a plurality of connecting portions 23′.

The plurality of concentric circle patterns of the inner zone heating element 24 may include a plurality of concentric arc portions 24a-1, 24a-2, 24b-1, and 24b-2 extending along the circumferential direction of the plate 20. In addition, the concentric circle patterns may also include a plurality of connecting portions 23′, each of which connects adjacent ones of the plurality of concentric arc portions 24a-1, 24a-2, 24b-1, and 24b-2. The adjacent ones of the arc portions 24a-1, 24a-2, 24b-1, and 24b-2 may be connected by each of the connecting portions 23′ extending in the diametric direction.

The plurality of concentric arc portions 24a-1, 24a-2, 24b-1, and 24b-2 may have different diameters. In addition, the plurality of connecting portions 23′ may be aligned parallel to each other to form separation areas 26 extending in the radial direction of the plate 20 therebetween on the plate 20.

The inner zone heating element 24 may include a first inner heating part 24a and a second inner heating part 24b. The first inner heating part 24a and the second inner heating part 24b may be configured to be connected to each other, forming a line-symmetrical structure about the diameter direction of the plate 20.

The arc portion 24a-1 of the first inner heating part 24a and the arc portion 24b-1 of the second inner heating part 24b have the same diameter. The arc portion 24a-2 of the first inner heating part 24a and the arc portion 24b-2 of the second inner heating part 24b also have the same diameter, and have a larger diameter than the arc portion 24a-1 and the arc portion 24b-1. The arc portion 24a-1 is connected to the arc portion 24a-2 by a connecting portion 23′. The arc portion 24b-1 is connected to the arc portion 24b-2 by another connecting portion 23′.

The connecting portion 23′ of the first inner heating part 24a and the connecting portion 23′ of the second inner heating part 24b may be spaced apart by a predetermined distance E and disposed to face each other. A separation area 26, in which the inner zone heating element 24 is not wired, may be formed on the plate 20 within an area defined by the imaginary lines I, created by the connecting portions 23′ spaced apart from each other. The separation area 26 may extend in the radial direction of the plate 20.

The separation area 26 may be formed between the first inner heating part 24a and the second inner heating part 24b. Preferably, the separation area 26 may be formed in an area where a plurality of connecting portions 23′ are aligned in parallel and extend in the radial direction of the plate 20. The separation area 26 may be formed at the center of the plate 20 in a direction to circumference.

The outer zone heating g element 25 forms a predetermined concentric circle pattern, starting from a second terminal 22a, is continuously wired in the outer area of the plate 20, and is then connected to another second terminal 22b. In this process, the outer zone heating element 25 may form a concentric circle pattern by being folded at predetermined positions, surrounding the inner zone heating element 24 (see FIG. 2), or may form multiple concentric patterns by folding at multiple connecting portions 23′ (see FIG. 3).

The plurality of concentric circle patterns of the outer zone heating element 25 may include a plurality of concentric arc portions 25a-1, 25a-2, 25b-1, and 25b-2 extending along the circumferential direction of the plate 20. In addition, the concentric circle patterns may also include a plurality of connecting portions 23′, each of which connects adjacent ones of the plurality of concentric arc portions 25a-1, 25a-2, 25b-1, and 25b-2. The adjacent ones of the arc portions 25a-1, 25a-2, 25b-1, and 25b-2 may be connected by each of the connecting portions 23′ extending in the diametric direction.

The plurality of concentric arc portions 25a-1, 25a-2, 25b-1, and 25b-2 may have different diameters. In addition, the plurality of connecting portions 23′ may be aligned parallel to each other to form separation areas 26 extending in the radial direction of the plate 20 therebetween on the plate 20.

The outer zone heating element 25 may include a first outer heating part 25a and a second outer heating part 25b. The first outer heating part 25a and the second outer heating part 25b may be configured to be connected to each other, forming a line-symmetrical structure about the diameter direction of the plate 20.

The arc portion 25a-1 of the first outer heating part 25a and the arc portion 25b-1 of the second outer heating part 25b have the same diameter. The outer zone heating element 25 may further include an arc portion 25a-2 of the first outer heating part 25a and an arc portion 25b-2 of the second outer heating part 25b. The arc portion 25a-2 and the arc portion 25b-2 have the same diameter and have a greater diameter than the arc portion 25a-1 and the arc portion 25b-1. The arc portion 25a-1 is connected to the arc portion 25a-2 by a connecting portion 23′. The arc portion 25b-1 is connected to the arc portion 25b-2 by another connecting portion 23′.

The connecting portion 23′ of the first outer heating part 25a and the connecting portion 23′ of the second outer heating part 25b may be spaced apart by a predetermined distance E and disposed to face each other. A separation area 26, in which the outer zone heating element 25 is not wired, may be formed on the plate 20 within an area defined by the imaginary lines I, created by the connecting portions 23′ spaced apart from each other. The separation area 26 may extend in the radial direction of the plate 20.

The separation area 26 may be formed between the first outer heating part 25a and the second outer heating part 25b. Preferably, the separation area 26 may be formed in an area where a plurality of connecting portions 23′ are aligned in parallel and extend in the radial direction of the plate 20. In addition, a separation area 26 may also be formed between a conductive connection portion 28 connected to the second terminal 22a and a conductive connection portion 28 connected to the second terminal 22b. A separation area 26 may be formed by extending from the separation area 26 formed in the inner area in a direction to circumference from the center of the plate 20.

The inner zone heating element 24 and the outer zone heating element 25 may be electrically isolated to operate independently of each other.

A first passage 27, into which a temperature sensor 60 such as a thermocouple is inserted, may be formed in the plate 20. The first passage 27 may be formed along and adjacent to the separation area 26. In addition, the first passage 27 may be formed parallel to the mounting surface 20a of the plate.

As illustrated in FIGS. 2 to 4, when viewed from above the plate 20 in the thickness direction, the first passage 27 may be formed adjacent to the separation area 26 so as not to overlap the heating element 23. In addition, the first passage 27 may be formed adjacent to the separation area 26 formed between the conductive connection portions 28 connected to the second terminals 22a and 22b.

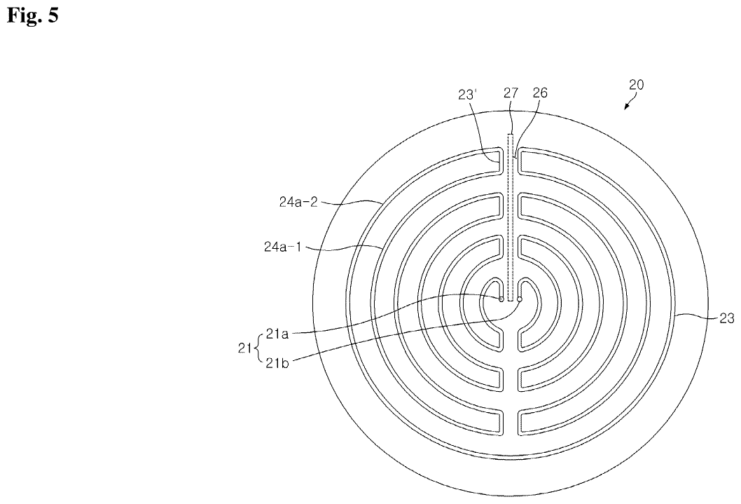

As illustrated in FIGS. 2 and 3, multiple heating elements, such as two heating elements 24 and 25, may be disposed independently of each other on the plate 20, or as illustrated in FIG. 5, a single heating element 23 may be disposed to cover all areas of the plate 20.

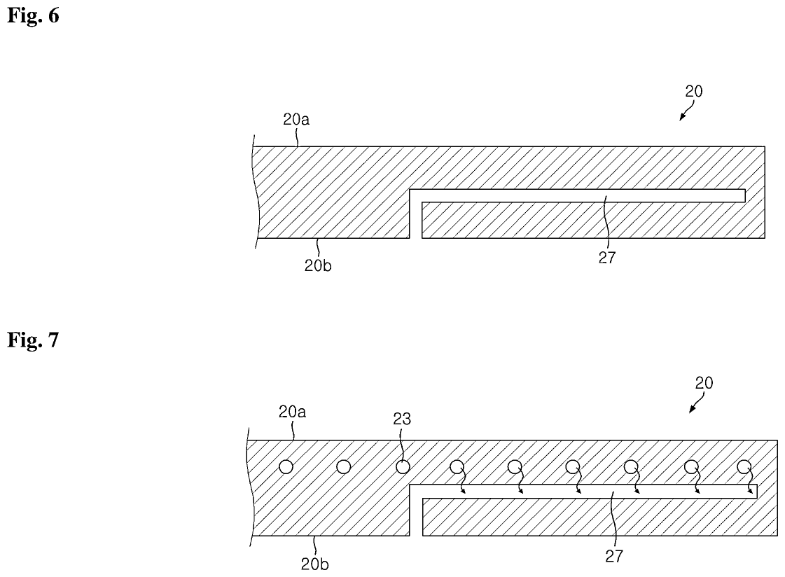

FIG. 6 is a cross-sectional view taken along line C-C′ of FIG. 2.

Referring to FIG. 6, since the first passage 27 is formed adjacent to and along the separation area 26, as illustrated in FIG. 6, the heating element 23 may not be disposed above the first passage 27. By forming the first passage 27 in an area where the heating element 23 is not densely packed, heat generated by the heating element 23 may be prevented from being lost through the first passage 27, thereby improving the temperature uniformity of the heater. In addition, this configuration may prevent cracks from occurring in vulnerable areas of the plate 20 due to the expansion and contraction of the heating element 23.

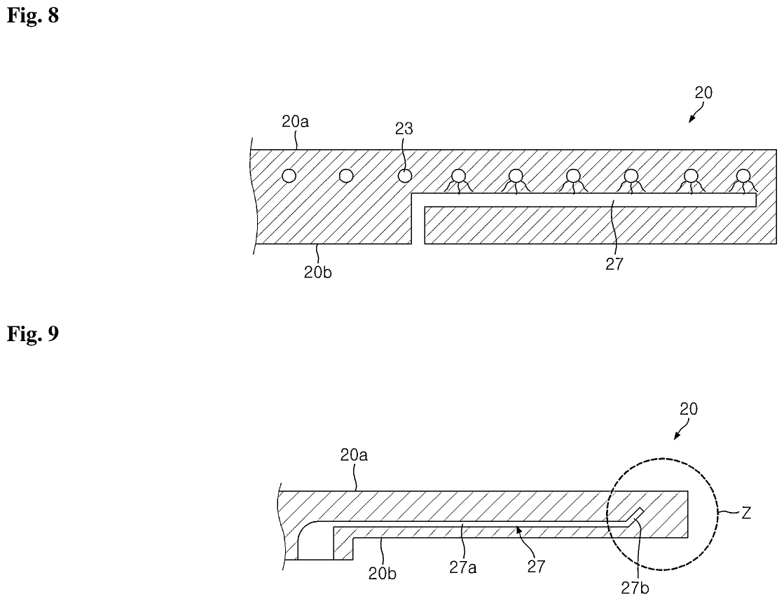

On the other hand, FIGS. 7 and 8 are views illustrating heat loss and microcracks that may occur when the first passage is formed in an area where the heating element is densely packed.

As illustrated in FIG. 7, when the first passage 27 is formed adjacent to the heating element 23, heat generated by the heating element 23 may be lost through the first passage 27.

Furthermore, as illustrated in FIG. 8, when the first passage 27 is formed adjacent to the heating element 23, microcracks may occur in the thinner portions of the plate 20 due to the expansion and contraction of the heating element 23.

FIG. 9 is a cross-sectional view of a plate according to another embodiment of the present disclosure taken along line C-C.

A temperature sensor 60, such as a thermocouple, is inserted into the first passage 27 of the plate 20. The first passage 27 may include an A-th passage portion 27a, formed parallel to the mounting surface 20a of the plate, and a B-th passage portion 27b inclined relative to the mounting surface 20a.

The B-th passage portion 27b is located at an end portion of the first passage 27 in a direction to circumference, where a temperature-sensing portion of the temperature sensor 60 may be located. By forming the B-th passage portion 27b to be inclined toward the heating element 23, the distance between the temperature-sensing portion of the temperature sensor 60 and the heating element 23 may be minimized. In addition, when the end portion of the B-th passage portion 27b in a direction to circumference is located at the same height as the heating element in the thickness direction of the plate, i.e., on the same plane, the temperature in the area between the heating element connecting portions 23′ may be measured more accurately.

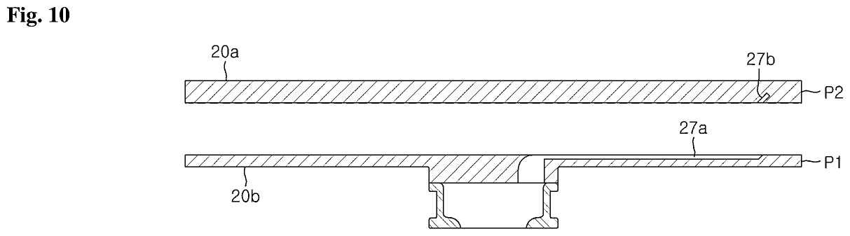

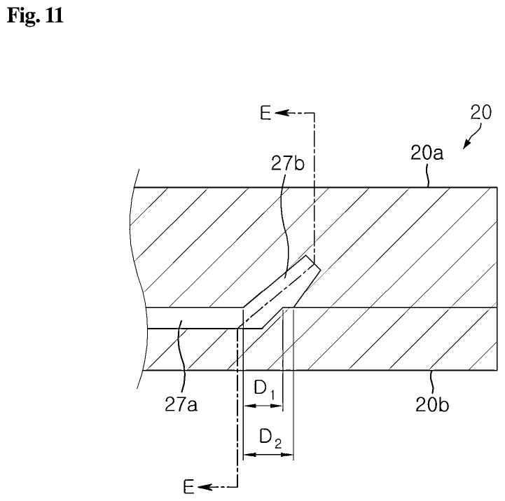

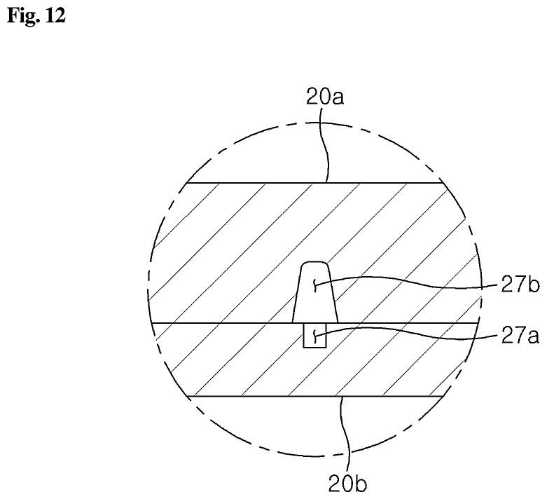

FIG. 10 is a view illustrating a process of manufacturing the plate shown in FIG. 9, FIG. 11 is an enlarged view of portion Z in FIG. 9, and FIG. 12 is a cross-sectional view taken along line E-E in FIG. 11.

The plate 20 may include an upper plate P2 and a lower plate P1. The upper plate P2 may have a B-th passage portion 27b formed therein, while the lower plate P1 may have an A-th passage portion 27a formed therein.

The A-th passage portion 27a and the B-th passage portion 27b may be grooves or holes extending in a direction to circumference of the plate 20 to allow the insertion of a temperature sensor 60, such as a thermocouple. The cross-sections of the A-th passage portion 27a and the B-th passage portion 27b may take various shapes, such as a circular shape or a rectangular shape.

The plate 20 may be manufactured by bonding the lower plate P1 having the A-th passage portion 27a and the upper plate P2 having the B-th passage portion 27b. In this case, when the A-th passage portion 27a and the B-th passage portion 27b are not precisely aligned, the space through which the temperature sensor 60 passes may be reduced, making it difficult or impossible to insert the temperature sensor 60 into the B-th passage portion 27b.

To facilitate alignment when bonding the upper plate P2 and the lower plate P1, as illustrated in FIG. 11, the B-th passage portion 27b may be machined into a cone shape, a polygonal cone shape such as a triangular or square pyramidal shape, a truncated cone shape, or a truncated polygonal cone shape. In this manner, by forming the cross-sectional area of the end portion of the B-th passage portion 27b smaller, the temperature-sensing portion of the thermocouple inserted into the B-th passage portion 27b is stabilized, thus improving temperature measurement accuracy.

Once the upper plate P2 and the lower plate P1 are bonded, an outlet of the A-th passage portion 27a, which is a hole through which the temperature sensor 60 is capable of passing, may be formed at one end portion of the A-th passage portion 27a in the lower plate P1. In addition, an inlet of the B-th passage portion 27b, which is a hole through which the temperature sensor 60 can pass, may be positioned in contact with the outlet of the A-th passage portion 27a.

Since the outlet of the A-th passage portion 27a and the inlet of the B-th passage portion 27b are in contact with each other, the A-th passage portion 27a and the B-th passage portion 27b may integrally form the first passage 27. In this case, to ensure that the space for the temperature sensor 60 to pass through is not reduced even if the A-th passage portion 27a and the B-th passage portion 27b are not correctly aligned, the inlet area D2 of the B-th passage portion 27b may be made greater than the outlet area D1 of the A-th passage portion 27a.

In addition, when an extra space of the inlet area D2 of the B-th passage portion 27b, i.e., the space corresponding to D2-D1, is located in a direction away from the center of the plate 20, a temperature sensor, such as a thermocouple, may be more easily inserted into the B-th passage portion 27b. In other words, the thermocouple inserted through the A-th passage portion 27a may be smoothly guided along the inner wall of the B-th passage portion 27b without hitting the upper plate P2 at the inlet of the B-th passage portion 27b.

In addition, the B-th passage portion 27b may be formed in a shape in which its cross-sectional area decreases in the direction away from the center of the plate 20.

By forming the inlet area D2 of the B-th passage portion 27b greater than the outlet area D1 of the A-th passage portion 27a, the plate 22 may be assembled while allowing for an alignment error in its radial direction (the left-right direction in FIG. 10). In addition, as illustrated in FIG. 12, by forming the width of the A-th passage portion 27a greater than the width of the B-th passage portion 27b, the plate 22 may be assembled while allowing for an alignment error in the rotating direction (the circumferential direction of the plate).

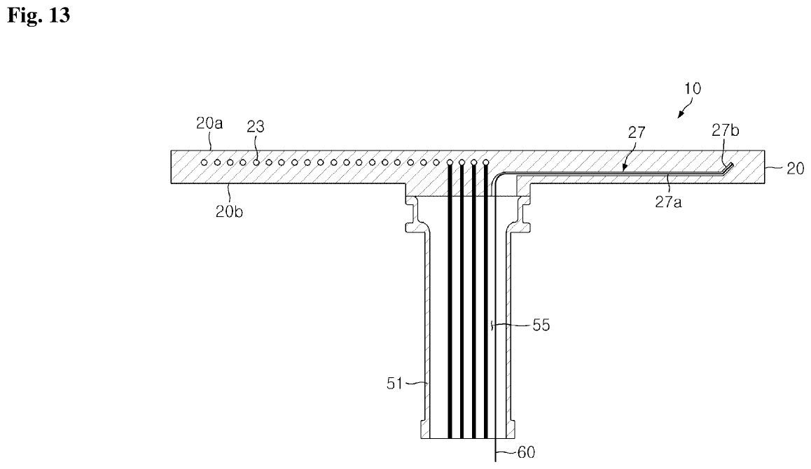

FIG. 13 is a cross-sectional view taken along line B-B of FIG. 1.

The shaft 50 may be configured in a cylindrical shape with a wall 51 of a predetermined thickness and an inner space (hollow portion) therein. In the inner space of the shaft 50, multiple rods 61a, 61b, 62a, and 62b, which are connected to the terminals of the plate, may be installed.

A temperature sensor 60, such as a thermocouple, may be inserted into the first passage 27 of the plate 20 through the hollow portion 55 of the shaft.

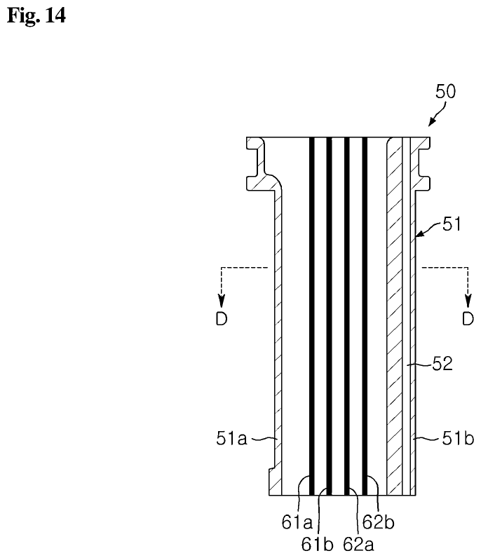

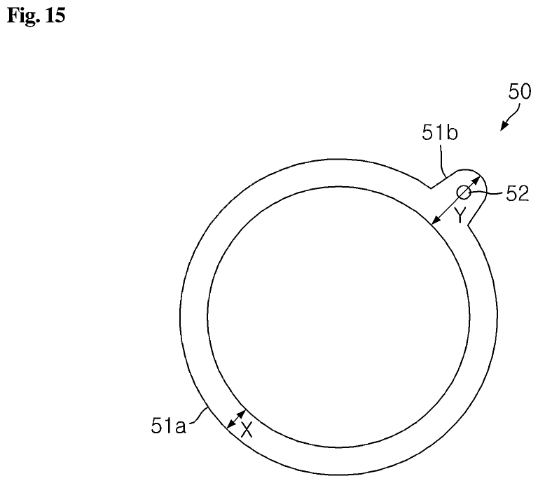

FIG. 14 is a cross-sectional view taken along line A-A of FIG. 1, illustrating a shaft according to an embodiment of the present disclosure, and FIG. 15 is a cross-sectional view taken along line D-D of FIG. 14.

The shaft 50 may be formed in a cylindrical shape with an inner space. In the inner space of the shaft 50, multiple rods 61a, 61b, 62a, and 62b, which are connected to the terminals of the plate, may be installed.

The shaft 50 may have a wall 51 with a predetermined thickness. Inside the wall 51, a second passage 52, which serves as a passage for inserting a temperature sensor 60 such as a thermocouple, may be formed along the longitudinal direction of the wall 51. Since the second passage 52 is connected to the first passage 27, the temperature sensor 60 may be inserted into the first passage 27 through the second passage 52.

The wall 51 may include a first thickness portion 51a with a first thickness X and a second thickness portion 51b with a second thickness Y. The second thickness is greater than the first thickness. The second passage 52 may be formed within the thickness of the wall 51, and preferably within the thicker second thickness portion 51b.

The second thickness portion 51b may be thicker than the first thickness portion 51a of the wall 51. Preferably, the second thickness portion 51b may protrude outward from the wall 51.

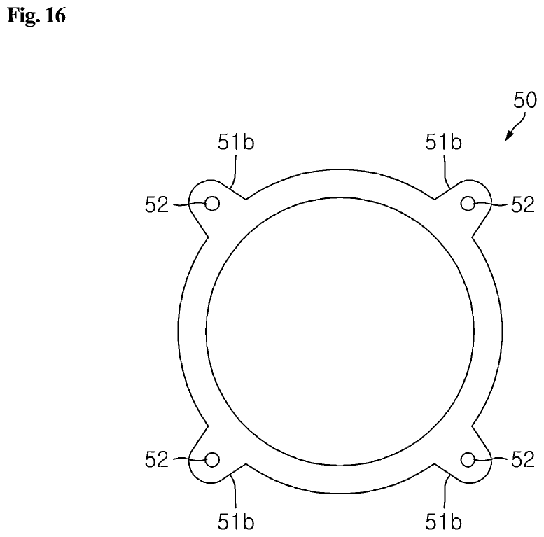

A plurality of second passages 52 may be provided corresponding to the number of required temperature sensors 60. FIG. 16 illustrates a configuration where four second thickness portions 51b are formed and a corresponding second passage 52 is formed in each of the second thickness portions 51b. When four second passages 52 are formed as illustrated in FIG. 16, four first passages 27 may also be formed in the plate 20. In this case, each first passage 27 is connected to a second passage 52, allowing each temperature sensor 60 to be inserted into the first passage 27 through the second passage 52.

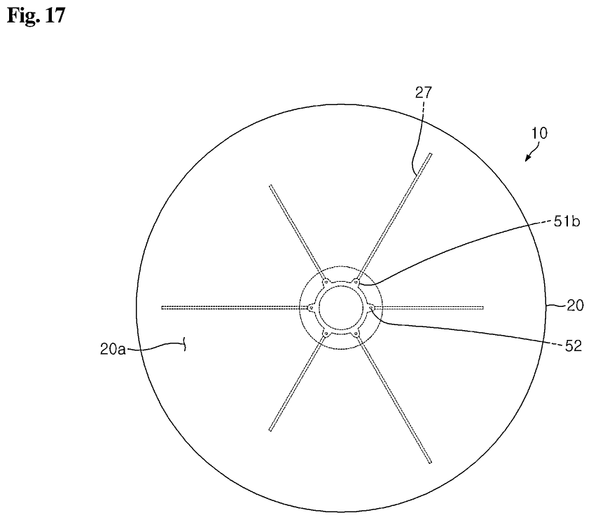

FIG. 17 is a plan view of a ceramic heater according to another embodiment of the present disclosure, illustrating the arrangement of a first passage and a second passage.

The ceramic heater 10 illustrated in FIG. 17 includes six first passages 27 and six second passages 52. The shaft 50 has six second thickness portions 51b, each of which is provided with a second passage 52. Each second passage 52 corresponds to and is connected with one of the six first passages 27 formed in the plate 20.

When multiple first passages 27 are formed as described with reference to FIGS. 16 and 17, multiple separation areas 26 may also be formed. That is, when four or six first passages 27 are formed, four or six separation areas 26 may be formed, respectively, in which each first passage 27 is disposed adjacent to a corresponding separation area 26.

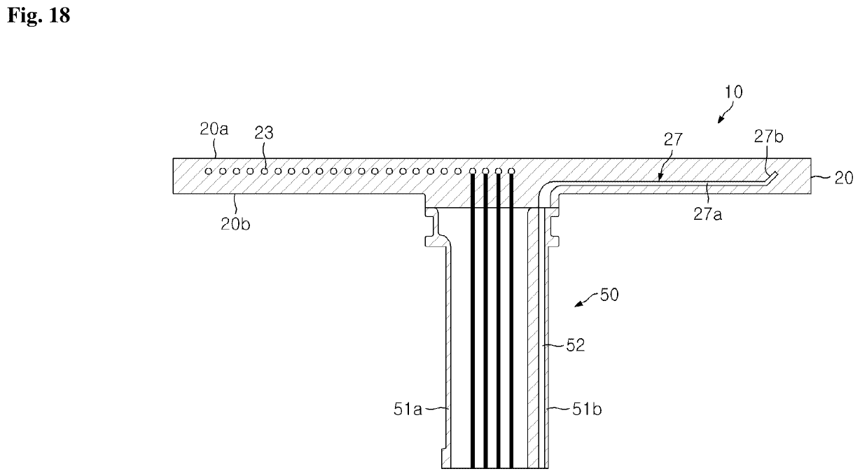

When there are multiple first passages 27, some of the first passages 27 may be formed only to the middle positions of the ceramic plate 20, as illustrated in FIG. 17. In this case, the temperature-sensing portions of the temperature sensors 60 may be positioned at different distances from the center of the plate 20 to measure temperature. FIG. 18 is a cross-sectional view taken along line B-B of FIG. 1, illustrating a shaft according to an embodiment of the present disclosure.

In the inner space of the shaft 50, multiple rods 61a, 61b, 62a, and 62b, which are connected to the terminals of the plate 20, are installed. Since a second passage 52 according to an embodiment of the present disclosure is positioned within the thickness of the wall 51 of the shaft, the second passage 52 may be formed independently of the positions of terminals 21a, 21b, 22a, and 22b or rods 61a, 61b, 62a, and 62b.

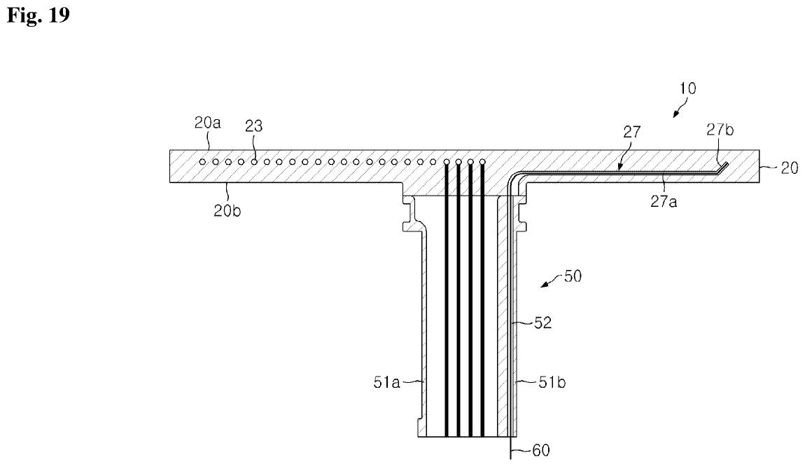

The second passage 52 formed within the wall 51 of the shaft 50 is connected to a first passage 27 in the plate 20. Thus, as illustrated in FIG. 19, a temperature sensor 60 may be inserted into the second passage 52 and the first passage 27.

In the foregoing, the present disclosure has been described based on specific details, such as concrete components, limited embodiments, and drawings, but these have been provided merely to aid a more comprehensive understanding of the present disclosure, and the present disclosure is not limited to the above-described embodiments. Various modifications and alterations may be made without departing from the essential characteristics of the present disclosure by a person ordinarily skilled in the art to which the present disclosure pertains. Therefore, the spirit of the present disclosure should not be limited to the described embodiments, and not only the appended claims, but also all technical ideas that are equivalent or have equivalent modifications to the claims should be construed as being included within the scope of the present disclosure. The above-described individual embodiments may be combined and utilized together as needed.

What is claimed is:

1. A ceramic heater comprising:
a plate comprising a heating element and a first passage; and
a shaft having a hollow portion,
wherein the heating element comprises a plurality of concentric arc portions and a plurality of connecting portions connecting the arc portions, the plurality of connecting portions being spaced apart and facing each other to form a separation area that extends in a radial direction of the plate, and
wherein the first passage is formed adjacent to the separation area.

2. The ceramic heater of claim 1, wherein the plurality of connecting portions are aligned parallel to each other to form the separation area extending in the radial direction of the plate.

3. The ceramic heater of claim 1, wherein the plate comprises a first heating part and a second heating part,
Wherein the second heating part is connected to the first heating part and symmetrically aligned with the first heating part, and
wherein the separation area is disposed between the first heating part and the second heating part.

4. The ceramic heater of claim 1, wherein the first passage does not overlap the heating element in a thickness direction of the plate.

5. The ceramic heater of claim 1, wherein a plurality of separation areas and a plurality of first passages are provided.

6. The ceramic heater of claim 5, wherein the plurality of first passages comprises at least two first passages with different lengths.

7. The ceramic heater of claim 1, wherein the shaft comprises a wall portion and a second passage, and
wherein the second passage is formed within the wall along a longitudinal direction of the wall portion.

8. The ceramic heater of claim 7, wherein the wall portion comprises a first thickness portion with a first thickness and a second thickness portion with a second thickness,
wherein the second thickness is greater than the first thickness, and
wherein the second passage is formed within the second thickness portion.

9. The ceramic heater of claim 8, wherein the second thickness portion protrudes outward from the wall portion.

10. The ceramic heater of claim 7, wherein the wall portion comprises a first thickness portion with a first thickness and a plurality of second thickness portions with a second thickness,
wherein the second thickness is greater than the first thickness,
wherein each of the plurality of second thickness portions has a second passage formed therein,
wherein a plurality of separation areas and a plurality of first passages are provided, and
wherein the plurality of second passages correspond to the plurality of first passages, respectively.

11. The ceramic heater of claim 1, wherein the first passage comprises an A-th passage portion parallel to a first surface of the plate and a B-th passage portion inclined relative to the first surface.

12. The ceramic heater of claim 11, wherein the plate comprises a first plate portion and a second plate portion, and
wherein the A-th passage portion is located in the first plate portion and the B-th passage portion is located in the second plate portion.

13. The ceramic heater of claim 11, wherein the B-th passage portion is inclined toward the heating element.

14. The ceramic heater of claim 13, wherein the B-th passage portion is located at an end portion of the first passage in a direction to circumference.

15. The ceramic heater of claim 11, wherein an outlet area of the A-th passage portion is smaller than an inlet area of the B-th passage portion.

16. The ceramic heater of claim 7, further comprising:
a thermocouple positioned within the first and second passages,
wherein the first passage comprises an A-th passage portion parallel to a first surface of the plate and a B-th passage portion inclined relative to the first surface,
wherein the B-th passage portion is located at an end portion of the first passage in a direction to circumference, and
wherein a temperature sensing portion of the thermocouple is located in the B-th passage portion.

17. The ceramic heater of claim 1, further comprising:
a thermocouple,
wherein the thermocouple is located within the hollow portion of the shaft and within the first passage.
